(19) United States
(12) Patent Application Publication
(10) Pub. No.: US 2005/0123292 A1
(43) Pub. Date: Jun. 9, 2005

(54) Methof for securing an optical telecommunication ring network and communication node amplifying communication node and traffic concentrator of a secured optical telecommunication ring network

(75) Inventors: Arnaud Bisson, Orsay (FR); Ludovic Noirie, Nozay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 10/502,353

(22) PCT Filed: Jan. 24, 2003
(86) PCT No.: PCT/FR03/00230

(30) Foreign Application Priority Data
Jan. 24, 2002 (FR) 0200860

(51) Int. Cl. G02F 1/00

(52) U.S. Cl. 398/3

(57) ABSTRACT

The present invention relates to the field of optical telecommunications networks, and more particularly to a method and to devices for backing up a ring optical telecommunications network. The method of the invention corresponds to a method of backing up a ring optical telecommunications network including a traffic concentrator (1) and a communications node (N3) interconnected by an optical fiber (2) (s1, s2) transported in the fiber and addressed to the node. The method of the invention comprises the following successive steps: while the network is being set up, a step of creating a virtual break (C) between the concentrator and the node; and when an at least partial real break in the fiber is detected that limits or interrupts the transmission of the signals to the node, a step of displacing the virtual break so that it coincides with the real break so as to re-establish the reception of the optical signals by the node.

The present invention relates to the field of optical telecommunications networks, and more particularly to a method and to devices for backing up a ring optical telecommunications network.

Networks such as some metropolitan area networks covering relatively large geographical areas and interconnecting local area networks less than 100 km apart have a ring architecture. This is known in the art. These networks generally comprise:
a traffic concentrator distributing downlink wavelength division multiplexed optical signals from a backbone network in the network and receiving uplink wavelength division multiplexed signals from inside the ring network and sending them to the backbone network,
an optical fiber dedicated to transporting downlink signals from a concentrator inside the network,
a separate optical fiber dedicated to transporting uplink signals addressed to the concentrator inside the network,
a respective so-called operating communications node associated with each of the two fibers, each comprising an optical add/drop multiplexer (OADM) and each adapted to drop a portion of the traffic by selecting one or more wavelengths of the downlink multiplexed signal in order to send that wavelength or wavelengths to a local area network and to add their own traffic at the concentrator by adding one or more wavelengths to the uplink multiplexed signal, whilst passing all transit wavelengths of the uplink and downlink multiplexed signals, and
amplified communications nodes each comprising an OADM and optical amplifier means disposed in each of the fibers to receive and amplify signals propagating within the ring network.

To assure the reception of downlink signals by the local area network, for example, even in the event of interruption of the ring network, prior art ring networks comprise an additional back-up fiber and an additional back-up communications node for each operating communications node, the back-up node being substantially identical to the operating node, connected to the same local area network, and associated with the back-up fiber.

To be more precise, the traffic concentrator duplicates the downlink signals. Some of these signals, called operating signals, are transported by a first optical fiber to the upstream side of the operating node in a given propagation direction. Others of these signals, called back-up signals, are transported by the back-up fiber to the upstream side of the back-up node in the direction opposite to that of the operating signals. Switching means connected to the first fiber and the back-up fiber then activate one of the nodes, as a function of the transmission state of the network, allowing operating or back-up downlink signals to enter the corresponding OADM.

Amplified communications nodes are naturally also inserted into the back-up fiber.

The documents U.S. Pat. No. 5,680,235 and WO 99/03230 describe ring networks of the above kind necessitating the use of two fibers to provide two operating states, namely normal transmission and backed up transmission in the event of a break in the ring.

Duplicating the optical fibers and the communications nodes, in particular the OADM and the amplifier means, leads to high additional costs, and for this reason prior art backed up networks are not satisfactory.

An object of the present invention is to develop a method and devices for backing up traffic in a ring optical telecommunications network at low cost.

To this end, the present invention proposes firstly a method of backing up a ring optical telecommunications network including a traffic concentrator and a communications node interconnected by an optical fiber of the network, the concentrator sending optical signals transported in the fiber and addressed to the node,

characterized in that it consists in using the same fiber in one direction when the network is in a normal transmission state and in the opposite direction when the network is in a standby transmission state.

Thus this method backs up the transmission of downlink optical signals sent by the concentrator because, in the event of a break in the ring, each node of the network receives downlink signals addressed to it from the end of the fiber opposite the end at the break, relative to that node.

The invention also proposes a communications node of a backed up ring optical telecommunications network, comprising:
an optical fiber section for transporting optical signals, and
extraction means for extracting optical signals transported by the fiber section,
   characterized in that, to allow the use of the same section of fiber in one direction when the network is in a normal transmission state and in the opposite direction when the network is in a backed up transmission state, and the extraction means are of the power coupler type and are bidirectional,
   and in that it further comprises:
switching means for directing optical signals extracted by the extraction means, and
control means for detecting the transmission state of the network and controlling the switching means as a function of that state.

The power coupler of the invention samples a fraction of the wavelength division multiplexed downlink signal instead of selecting one or more wavelengths in that signal, like the prior art OADM. A coupler of this kind is less costly than an OADM and is able to broadcast the same wavelength to a plurality of nodes.

The node may preferably comprise an optical gate for passing or eliminating optical signals, controlled by the control means and inserted into the fiber section.

For example, the optical gate eliminates all of the poor quality residual downlink signal in the event of a partial break in the fiber.

The invention further provides a communications node of a backed up ring optical telecommunications network, comprising:
an optical fiber section for transporting optical signals, and
insertion means for inserting optical signals into the fiber section,
   characterized in that, to allow the use of the same section of fiber in one direction when the network is in a normal transmission state and in the opposite direction when the network is in a backed up transmission state, the insertion means are of the power coupler type and are bidirectional,
   and in that it further comprises:
switching means for directing optical signals to be inserted into the fiber section toward the insertion means, and
control means for detecting the transmission state of the network and controlling the switching means as a function of that state.

The insertion means of the invention inject optical signals into the fiber section in both propagation directions.

Similarly, the invention provides an amplified communications node of a backed up ring optical telecommunications network, comprising:
at least one optical fiber section for transporting optical signals, and
amplifier means for each fiber section inserted into the associated fiber section to amplify optical signals,

characterized in that, to allow the use of the same section of fiber in one direction when the network is in a normal transmission state and in the opposite direction when the network is in a back-up transmission state, it further comprises:
switching means for each fiber section, inserted into the associated fiber section, for directing optical signals toward the associated amplifier means, and
control means for detecting the transmission state of the network and controlling the switching means as a function of that state.

The amplified communications node of the invention may preferably comprise power coupler type extraction means for extracting downlink optical signals transported by the fiber section of the network dedicated to transporting downlink signals.

The amplified communications node of the invention may preferably comprise power coupler type insertion means for inserting uplink optical signals into the fiber section of the network dedicated to transporting uplink signals.

The invention further relates to a traffic concentrator of a backed up ring optical telecommunications network, characterized in that, to allow the same fiber section to be used in one direction when the network is in a normal transmission state and in the opposite direction when the network is in a standby transmission state, it comprises:
two separate sections of a first optical fiber,
switching means connected to one end of each of the sections of the first fiber to inject into these two ends substantially identical optical signals addressed to nodes of the network,
switching means connected to one end of each of the sections of the second fiber to receive via one of those two ends an optical signal sent by a node of the network, and
control means for detecting the transmission state of the network and controlling the switching means as a function of that state.

The switching means may preferably comprise optical switches operating two by two.

The switching means advantageously comprise three-state optical switches forming a quadripole A, B, C, D and allowing optical signals to propagate between the four poles in any of the following three propagation modes:
between the poles A and B, on the one hand, and between the poles C and D, on the other hand, corresponding to a direct propagation mode;
between the poles A and C, on the one hand, and between the poles B and D, on the other hand, corresponding to a crossed propagation mode;
between the poles A and D, on the one hand, and between the poles B and C, on the other hand, corresponding to a transparent propagation mode.

Features and objects of the present invention emerge from the detailed description given below with reference to the appended drawings, which are provided by way of illustrative and non-limiting example.

In the drawings:

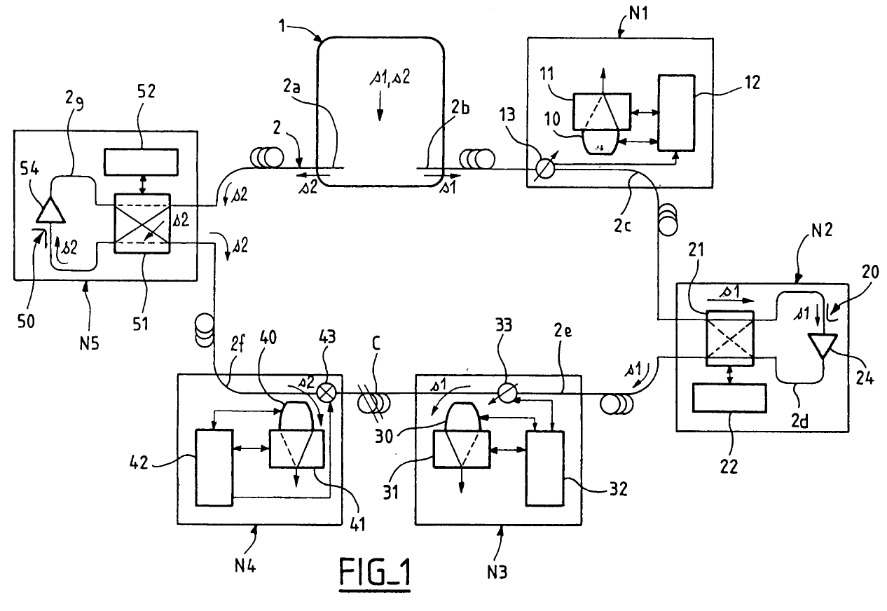

FIG. 1 is a diagram of a backed up optical telecommunications network comprising nodes conforming to one preferred embodiment of the invention, this diagram showing the normal state of transmission of downlink signals via a first fiber of the network,

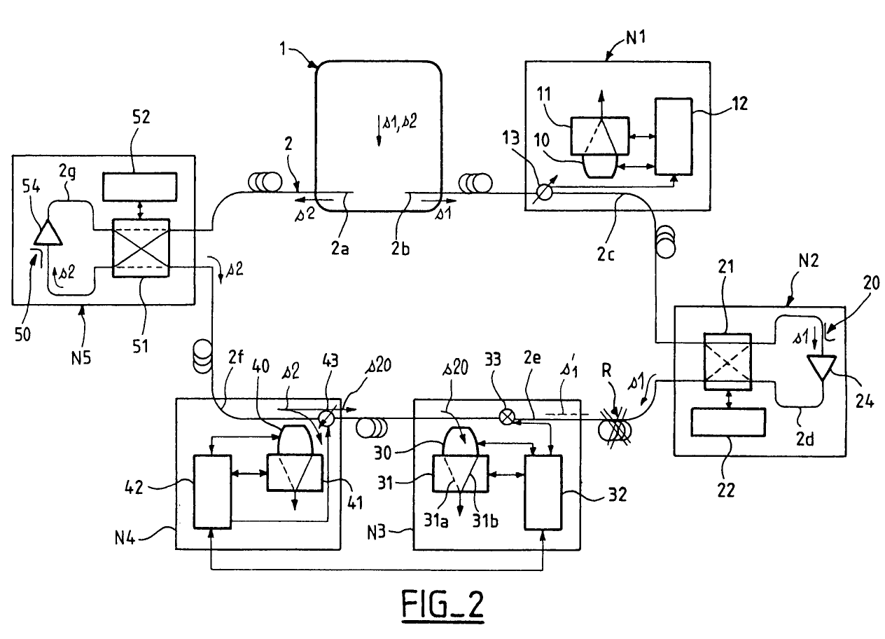

FIG. 2 is a diagram of the FIG. 1 network showing the transmission of downlink signals in the event of a break in the first fiber,

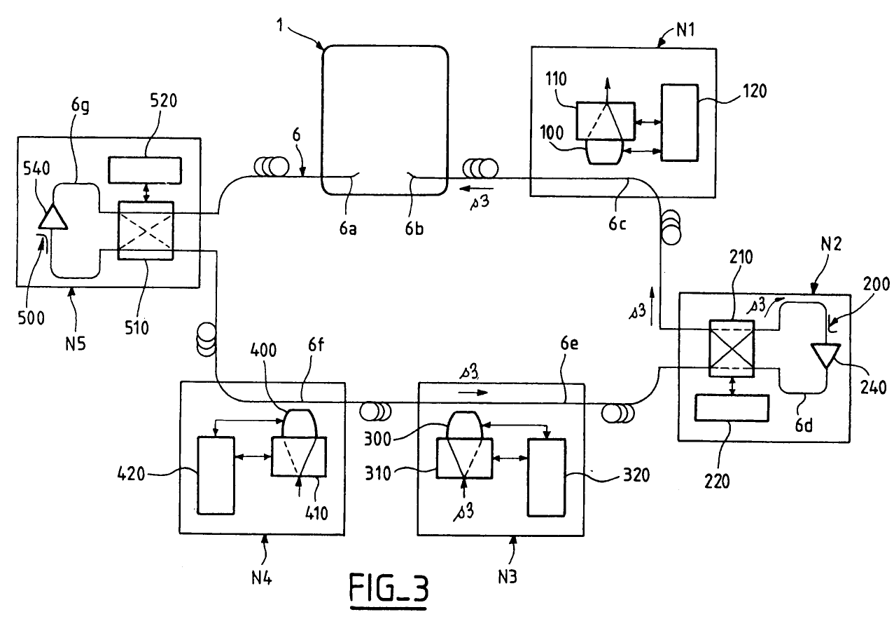

FIG. 3 is a diagram of the FIG. 1 network showing the normal state of transmission of an uplink signal by a second fiber of the network,

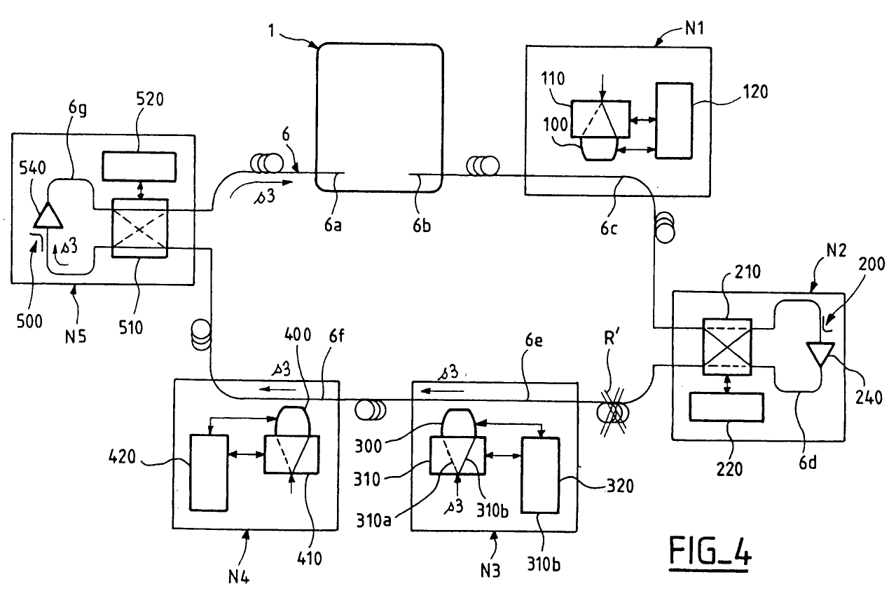

FIG. 4 is a diagram of the FIG. 3 network showing the transmission of an uplink signal in the event of a break in the second fiber,

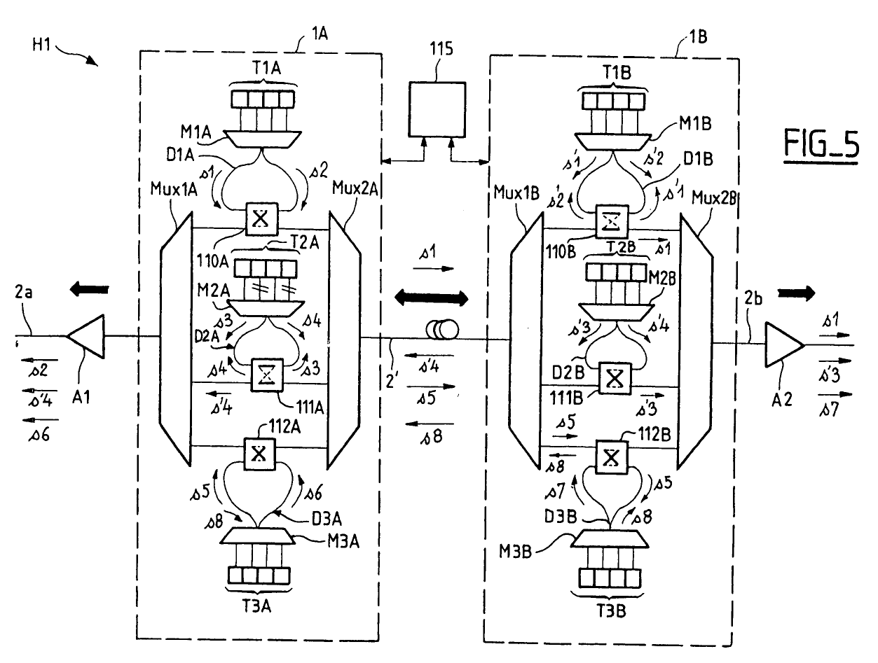

FIG. 5 is a partial view of a traffic concentrator conforming to one preferred embodiment of the invention, showing how the sending of downlink signals is backed up,

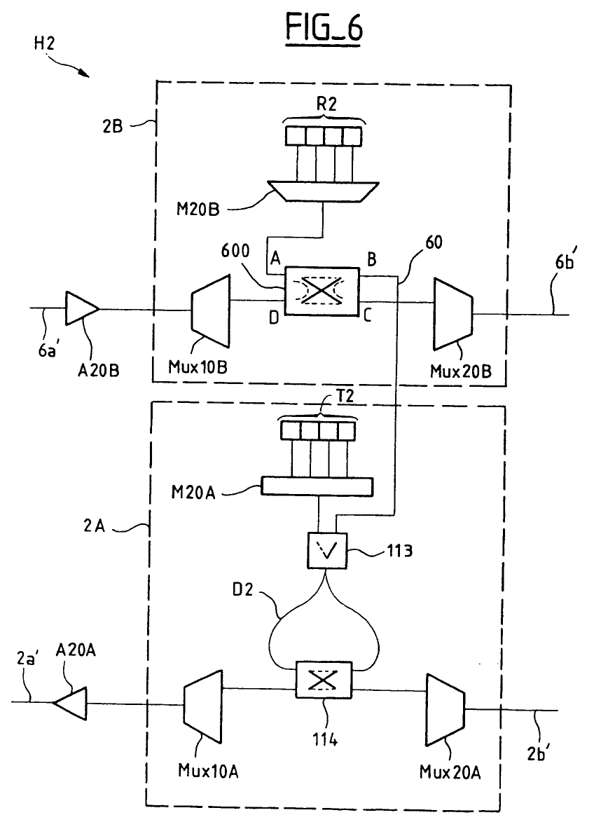

FIG. 6 is a partial view of a traffic concentrator conforming to another preferred embodiment of the invention, and

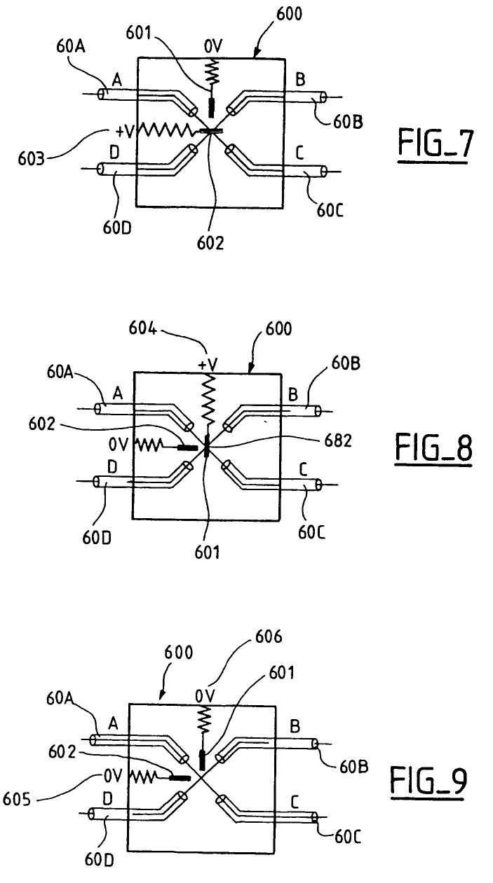

FIGS. 7 to 9 represent a three-way switch that is part of the FIG. 6 concentrator.

FIG. 1 is a diagram of a backed up optical telecommunications network comprising nodes conforming to a first preferred embodiment of the invention, this diagram showing the normal state of transmission of downlink signals via a first optical fiber of the network. The network comprises:
a traffic concentrator 1 sending substantially identical downlink wavelength division multiplexed signals simultaneously on each side,
a first optical fiber 2 dedicated to transporting downlink signals and comprising in particular two fiber sections 2a, 2b belonging to the concentrator 1 for injecting downlink signals into one end of each section, and
communications nodes N1, N3, N4 and amplified nodes N2, N5 optically connected to the concentrator 1 by the fiber 2.

According to the invention, each communications node N1, N3, N4 comprises:
a section 2c, 2e, 2f of the fiber 2,
power coupler type bidirectional extraction means 10, 30, 40 for extracting a fraction of the power of the optical signals in transit in the node via its fiber section,
2×1 switch type switching means 11, 31, 41 with two branches for directing signals extracted by the respective extraction means 10, 30, 40,
control means 12, 32, 42 for detecting the transmission state of the network, i.e. of the fiber 2, and controlling the switching means 11, 31, 41 as a function of that state, and
an optical gate 13, 33, 43 for transmitting or eliminating optical signals and controlled by the respective control means 12, 32, 42.

Moreover, each amplified communications node N2, N5 comprises:
a section 2d, 2g of the fiber 2,
2×2 optical switch type switching means 21, 51 with two states (direct propagation mode, crossed propagation mode) inserted into the respective fiber section 2d, 2g for directing the transported signals to optical amplifier means 24, 54 also inserted into this fiber section,
control means 22, 52 for detecting the transmission state of the network, i.e. of the fiber 2, and controlling the switching means 21, 51 as a function of that state, and
power coupler type extraction means 20, 50 for extracting optical signals transported by the respective fiber section 2d, 2g.

Thus the concentrator 1 sends simultaneously to the ends of the fiber sections 2a, 2b substantially identical optical signals s1, s2 whose path is represented in FIG. 1. According to one essential feature of the invention, a virtual break is created between two nodes while the network is being set up or reconfigured. This break C is preferably between the two adjacent nodes N3, N4 of the concentrator 1 that are at the greatest distance from each other, and is produced by locking the optical gate 43 of the node N4, for example. Thus under normal circumstances there is no communications between these nodes.

The network of the invention essentially organizes traffic between the concentrator 1, on the one hand, and the nodes N1 to N5, on the other hand, the object being to back up this type of traffic, as explained hereinafter. However, the invention does not prevent internode traffic existing simultaneously, including traffic between nodes on either side of the virtual break C, although this traffic does not have the same guarantee of back-up in the event of a break in the fiber.

FIG. 2 is a diagram of the FIG. 1 network showing the transmission of downlink signals s1, s2 when there is a break R in the first fiber 2 between the nodes N2 and N3, for example.

When the break R is detected and localized, for example by the means 32 of the node N3, the virtual break is shifted step by step toward the physical break R until it coincides with it.

To this end, the optical gate 43 controlled by the means 42 in conjunction with the means 32 is unlocked and then authorizes sending the optical signals s20 coming from the end 2a as far as the node N3, to enable reception of the optical signal that is addressed to it.

Thus a fraction of the signal s20 is sampled from the fiber section 2e by the bidirectional extraction means 30 and then directed into the branch 31b of the switch 31 instead of the branch 31a; this is controlled automatically by the means 32. In this way the direction of reception of optical signals by the node N3 is reversed compared to the normal mode of operation of the network.

In parallel with this, the optical gate 33, which is also controlled by the means 33, is locked. In the case of a partial break in particular, this allows the sending of a signal s′1 with a high error rate (dashed line path), preventing it from mixing with the good quality optical signal s20.

FIG. 3 is a diagram of the FIG. 1 network showing the normal state of transmission of an uplink signal by a second fiber of the network 6 dedicated to transporting uplink signals.

All the communications nodes N1 to N5 are optically connected to the concentrator 1 via the fiber 6, which includes in particular two fiber sections 6a, 6b belonging to the concentrator 1 for receiving uplink optical signals. Each node N1 to N5 is capable of sending uplink signals at different wavelengths from the other nodes.

According to the invention, each communications node N1, N3, N4 comprises:
a section 6d, 6g of the fiber 6,
power coupler type bidirectional insertion means 100, 300, 400 for inserting optical signals into its fiber section,
2×1 switch type switching means 110, 310, 410 with two branches for directing the signals sent to the respective insertion means 100, 300, 400, and
control means 120, 320, 420 for detecting the transmission state of the network, i.e. of the fiber 6, and controlling the switching means 110, 310, 410 as a function of that state.

Moreover, each amplified communications node N2, N5 comprises:
a section 6d, 6g of the fiber 6,
2×2 optical switch type switching means 210, 510 with two states (direct propagation mode, crossed propagation mode) inserted into the respective fiber section 6d, 6g for directing signals transported by the associated fiber section to optical amplifier means 240, 540 also inserted into this fiber section,
control means 220, 520 for detecting the transmission state of the network, i.e. of the fiber 6, and controlling the switching means 210, 510 as a function of that state, and
power coupler type insertion means 200, 500 for inserting optical signals into the associated fiber section ahead of the amplifier means 240, 540.

The uplink signals propagate in a propagation direction determined as a function of the branch of the optical switch chosen in the sender node.

For example, the node N3 sends an uplink optical signal s3 whose path in normal operation is as shown in FIG. 3. This signal s3 is received by the concentrator 1 via the fiber section 6b.

FIG. 4 is a diagram of the FIG. 3 network showing the transmission of the uplink signal s3 when there is a break R′ in the second fiber 6 between the nodes N2 and N3, for example.

The break R is detected and localized by the means 320 of the node N3, for example. The signal s3 is then directed into the branch 310b of the switch 31 instead of the branch 310a, then inserted into the fiber section 6e by the bidirectional extraction means 300, and finally sent to the concentrator 1 via the fiber section 6a instead of the fiber section 6b, as in normal operation.

FIG. 5 is a partial view of a concentrator conforming to a preferred embodiment of the invention, showing how the sending of downlink signals is backed up. To double up the backing up of downlink traffic, the concentrator H1 is doubled up in two parts 1A, 1B each of which comprises:
three series of senders T1A to T3B for sending optical signals at different given wavelengths,
a wavelength division multiplexer/demultiplexer M1A to M3B for each series of senders for multiplexing the signals from a given series of senders, among other things,
a power splitter D1A to D3B for each series of senders, for splitting multiplexed signals into two identical signals,
2×2 optical switch type switching means 110A to 112B for each series of senders, with two states (direct propagation mode, crossed propagation mode), for receiving downlink signals and directing them to the nodes,
two multiplexers/demultiplexers Mux1A, Mux2A, Mux1B, Mux2B for multiplexing signals from the various series of senders, among other things,
an amplifier A1, A2 receiving signals multiplexed by respective multiplexers/demultiplexers Mux1A, Mux2B, and
control means 115 for detecting the transmission state of the network, i.e. the transmission quality of the downlink signals, and controlling the switching means 110A to 112B as a function of that state.

The parts 1A and 1B are connected by a bidirectional fiber section 2′. Each of the parts 1A, 1B is also connected to a fiber section end 2a, 2b of a first fiber, in order to inject into the sections 2a, 2b substantially identical optical signals addressed to nodes of the network.

The concentrator H1 also comprises:
two fiber sections of a second fiber (not shown) separate from first optical fiber and other switching means (not shown) connected to one end of each of the second fiber sections to receive via one of those ends an optical signal sent by a node of the network, and
control means (not shown) for detecting the transmission state of the second fiber and controlling the associated switching means as a function of that state.

The switches of the two parts 1A and 1B operate two by two. There are three possible configurations, which are described along the optical signal path from the senders as far as their injection into the fiber sections 2a, 2b.

In normal operation of the concentrator H1, the switches are set like the switches 110A, 110B, respectively to the crossed position and the direct position. The substantially identical downlink signals s1 and s2 are sent by the concentrator H1 with opposite propagation directions in the fiber sections 2a, 2b and the double back-up signals s′1 and s′2 are not used.

In the event of a sending problem, here between the terminals T2A and the multiplexer/demultiplexer M2A, the switches are set like the switches 111A, 111B, respectively to the direct position and the crossed position. Because the downlink signals s3 and s4 are unreliable in this situation, the double back-up signals s′3 and s′4 are sent by the concentrator 1 in opposite propagation directions in the fiber sections 2a, 2b.

The switches may also be set like the switches 112A, 112B, i.e. in crossed positions. In this case, one of the send downlink signals s5, s6 in the part 1A is injected into the fiber section 2a. One of the double back-up downlink send signals s7, s8 in the part 1B, which is identical to the signal s5, is also injected into the fiber section 2b.

FIG. 6 is a partial view of a traffic concentrator H2 conforming to another preferred embodiment of the invention.

The concentrator H1 comprises four fiber sections 2a′, 2b′, 6a′, 6b′ of two different optical fibers respectively dedicated to transporting downlink and uplink signals in the network.

The concentrator H2 more particularly comprises two parts 2A, 2B for managing downlink signals and uplink signals, respectively.

The part 2A comprises:
a plurality of series of senders T2 (of which only one is shown) of optical signals having different wavelengths,
a wavelength division multiplexer/demultiplexer M20A for each series of senders,
first 2×1 optical switch type switching means 113 for each series of senders, with two branches for receiving uplink optical signals to be forwarded and downlink signals,
a power splitter for each series of senders D2 for splitting the multiplexed signals into two identical signals,
2×2 optical switch type second switching means 114 for each series of senders, with two states (direct propagation mode, crossed propagation mode), for directing signals addressed to the destination nodes,
two multiplexers/demultiplexers Mux10A, Mux20A, for multiplexing signals from the various series of senders and injected into the fiber sections 2a′, 2b′, for example,
an amplifier A20A inserted into the fiber section 2a′ receiving the signals multiplexed by the multiplexer/demultiplexer Mux10A, and
control means (not shown) for detecting the transmission state of the network, i.e. the transmission quality of the downlink signals, and controlling the switching means 113, 114 as a function of that state.

The part 2B comprises:
a plurality of series of receivers R2 (of which only one is shown) of optical signals having different given wavelengths,
a wavelength division multiplexer/demultiplexer M20B for each series of receivers,
2×2 optical switch type switching means 600 for each series of receivers, with three states (direct propagation mode, crossed propagation mode, transparent mode), forming a quadripole A, B, C, D receiving uplink signals and directing them to the receivers R2 or the part 2A via an interconnection fiber 60,
two multiplexers/demultiplexers Mux10B, Mux20B,
an amplifier A20B receiving multiplexed uplink signals from the fiber sections 6a′, and
control means (not shown) for detecting the transmission state of the network, i.e. the reception quality of the uplink signals, and controlling the switching means 600 as a function of that state.

FIGS. 7 to 9 show in more detail one embodiment of a three-state optical switch 600 forming a quadrilateral ABCD. They generally employ micro-electro-mechanical (MEM) techniques used for small and very small electrically driven mechanical devices. The optical switch 600 comprise a vertical mirror 601 and a horizontal mirror 602, both moved mechanically by the effect of an electrical voltage in order to orient the optical signals, and light pipes 60A to 60D.

In FIG. 7, a voltage 603 is applied to the horizontal mirror 602 with two reflective faces, which is moved to direct optical signals from A to B and from C to D. This state of the switch 600 corresponds to the direct propagation mode.

In FIG. 8, a voltage 604 is applied to the vertical mirror 601 with two reflective faces, which is moved to direct optical signals from A to D and from B to C. This state of the switch 600 corresponds to the transparent propagation mode.

In FIG. 9, the switch 600 is in an unoperated state that corresponds to the crossed propagation mode, meaning that optical signals pass freely between the light pipes 60A to 60D, between A and C and between B and D, with no need to apply a voltage to the control pins 605 and 606. The two mobile mirrors 601 and 602 are in their rest position.

It will of course be noted that producing an optical switch as described above necessarily implies that no voltage is applied simultaneously to the pins 605 and 606, as this might destroy the switch. This is simple to achieve using an exclusive-OR type logic circuit (not shown) to prevent simultaneous activation of the two mirrors 601, 602.

Of course, the foregoing description has been given by way of purely illustrative example. Any means may be replaced by equivalent means without departing from the scope of the invention.

In particular, the means for controlling downlink signal traffic may be combined with the means for controlling uplink signal traffic.

Moreover, a traffic concentrator of the invention may comprise two identical parts for double backing up of downlink signal traffic as described for the concentrator H1 and an interconnection fiber for communications between downlink and uplink traffic as described for the concentrator H2.

The means for switching the uplink traffic of a concentrator in accordance with the invention may comprise pairs of 2×2 optical switches with two states, instead of three-state optical switches.

1-10. (canceled)

11. A communications node (N1, N3, N4) of a backed up ring optical telecommunications network, comprising:
an optical fiber section (2c, 2e, 2f) for transporting optical signals (s1, s2), and
extraction means (10, 30, 40) for extracting optical signals transported by the fiber section,
characterized in that, to allow the use of the same section of fiber in one direction (s1) when the network is in a normal transmission state and in the opposite direction (s2) when the network is in a backed up transmission state, the extraction means (10, 30, 40) are of the power coupler type and are bidirectional,
and in that it further comprises:
switching means (11, 31, 41) for directing optical signals extracted by the extraction means, and
control means (12, 32, 42) for detecting the transmission state of the network and controlling the switching means as a function of that state.

12. A communications node (N1, N3, N4) according to claim 11, characterized in that it comprises an optical gate (13, 33, 43) controlled by the control means (12, 32, 42) and inserted into the fiber section (2c, 2e, 2f) to pass or eliminate optical signals.

13. A communications node (N1, N3, N4) of a backed up ring optical telecommunications network, comprising:
an optical fiber section (6c, 6e, 6f) for transporting optical signals, and
insertion means (100, 300, 400) for inserting optical signals into the fiber section,
characterized in that, to allow the use of the same section of fiber in one direction (s1) when the network is in a normal transmission state and in the opposite direction (s2) when the network is in a backed up transmission state, the insertion means (100, 300, 400) are of the power coupler type and are bidirectional,
and in that it further comprises:
switching means (110, 310, 410) for directing optical signals to be inserted into the fiber section toward the insertion means, and
control means (120, 320, 420) for detecting the transmission state of the network and controlling the switching means as a function of that state.

14. An amplified communications node (N2, N5) of a backed up ring optical telecommunications network, comprising:
at least one optical fiber section (2d, 6d, 2g, 6g) for transporting optical signals, and amplifier means (24, 240, 54, 540) for each fiber section inserted into the associated fiber section to amplify optical signals,
characterized in that, to allow the use of the same section of fiber in one direction (s1) when the network is in a normal transmission state and in the opposite direction (s2) when the network is in a backed up transmission state, it further comprises:
switching means (21, 210, 51, 510) for each fiber section, inserted into the associated fiber section, for directing optical signals toward the associated amplifier means, and
control means (22, 220, 52, 520) for detecting the transmission state of the network and controlling the switching means as a function of that state.

15. An amplified communications node (N2, N5) according to claim 14, characterized in that it comprises power coupler type extraction means (20, 50) for extracting downlink optical signals transported by the fiber section of the network (2d, 2g) dedicated to transporting downlink signals.

16. An amplified communications node according to claim 14, characterized in that it comprises power coupler type insertion means (200, 500) for inserting uplink optical signals into the fiber section of the network (6d, 6g) dedicated to transporting uplink signals.

17. A traffic concentrator (H1, H2) of a backed up ring optical telecommunications network, characterized in that, to allow the same section of fiber to be used in one direction (s1) when the network is in a normal transmission state and in the opposite direction (s2) when the network is in a standby transmission state, it comprises:
two separate sections of a first optical fiber (2a, 2b, 2a′, 2b′),
switching means (110A to 112B) connected to one end of each of the sections of the first fiber to inject into these two ends substantially identical optical signals addressed to nodes of the network,
switching means (600) connected to one end of each of the sections of the second fiber to receive via one of those two ends an optical signal sent by a node of the network, and
control means for detecting the transmission state of the network and controlling the switching means as a function of that state.

18. A traffic concentrator (H1) according to claim 17, characterized in that the switching means (110A to 112B) comprise optical switches operating two by two.

19. A traffic concentrator (H2) according to claim 17, characterized in that the switching means (600) comprise three-state optical switches forming a quadripole A, B, C, D and allowing optical signals to propagate between the four poles in any of the following three propagation modes:
between the poles A and B, on the one hand, and between the poles C and D, on the other hand, corresponding to a direct propagation mode;
between the poles A and C, on the one hand, and between the poles B and D, on the other hand, corresponding to a crossed propagation mode;
between the poles A and D, on the one hand, and between the poles B and C, on the other hand, corresponding to a transparent propagation mode.
